(19) United States
(12) Patent Application Publication
(10) Pub. No.: US 2013/0071720 A1
(43) Pub. Date: Mar. 21, 2013

(54) COOLING ELEMENT, METHOD FOR PRODUCING SAME AND ELECTROCHEMICAL ENERGY STORAGE DEVICE COMPRISING A COOLING ELEMENT

(71) Applicant: Christian Zahn, Dresden (DE)

(72) Inventor: Christian Zahn, Dresden (DE)

(73) Assignee: Li-Tec Battery GmbH, Kamenz (DE)

(21) Appl. No.: 13/698,220

(22) PCT Filed: May 19, 2011
(86) PCT No.: PCT/EP2011/002513

§ 371 Date: Nov. 15, 2012

(30) Foreign Application Priority Data
May 28, 2010 (DE) 10 2010 021 922.3

(51) Int. Cl. H01M 10/50; B23P 19/04; F28F 9/007

(52) U.S. Cl. CPC H01M 10/50; F28F 9/007; B23P 19/04
USPC 429/120; 165/168; 165/81; 165/67; 29/890.039

(57) ABSTRACT

The invention relates to a cooling element, which is designed and equipped in particular to be disposed between electrochemical energy storage cells, comprising a heat exchanger structure through which a heat transfer medium can flow and which is formed at least substantially of two film layers or film layer structures, the opposing surfaces of which are placed against one another and which are connected at junctures within the surfaces, wherein the junctures define cavities between the surfaces, wherein the heat transfer medium can be conducted through said cavities.

The present invention relates to a cooling element, in particular for disposing between electrochemical energy storage cells as well as to a method for manufacturing the same. The invention also relates to an electrochemical energy storage device comprising a cooling element between respectively two storage cells.

The FR 2 694 136 A1 has disclosed cooling elements for disposing between flat stacked battery cells in a battery array. The cooling elements are implemented as heat exchanger plates consisting of parallel metallic plates with pipes arranged in-between or a corrugated metal sheet arranged in-between for forming coolant channels for the passing-through of air or another coolant. The battery array includes three cooling elements, i.e. two each at the frontal end and one in the centre of the stack between two cells. The cooling elements are designed and equipped for cooling by means of air. Since only a few cooling elements are provided the coolant volume and thus the cooling capacity of the arrangement as a whole is limited. Construction of the cooling elements is complex, the cooling elements are thick when compared to the battery elements and the manufacturing method is comparatively expensive.

From the DE 10 2008 034 869 A1 a battery with several battery cells interconnected with one another is known, wherein a heat-conducting element is disposed between two adjacent battery cells, respectively, which elements pass their heat absorbed by the battery cells to a common cooling plate disposed below the battery cells. The heat absorbing and heat dissipating capacity of the passively-acting heat-conducting elements is limited.

### SUMMARY OF THE INVENTION

It is a requirement of the present invention to improve the construction according to the prior art, in particular (but not exclusively) in view of the above-mentioned aspects.

The requirement is met, at least partially, by the features cited in the independent claims. Advantageous further developments of the invention are the subject of the sub-claims.

According to one aspect of the invention a cooling element designed and equipped to be disposed between electrochemical energy storage cells comprises a heat exchanger structure through which a heat transfer medium can flow, which heat exchanger structure is formed, at least substantially, of two film layers or film layer structures, the opposing surfaces of which are placed against one another and which are connected at junctures within the surfaces, wherein the junctures define cavities between the surfaces, wherein the heat transfer medium can be conducted through said cavities.

A cooling element in terms of the invention is understood to mean a structural element which is also capable of cooling adjacent surfaces, in particular surfaces of electrochemical energy storage cells, in between which it is disposed. A heat transfer medium in terms of the invention is understood to mean a medium, in particular a fluid, which is also capable of absorbing and transporting heat in order to dissipate it, for example, at another location. An electrochemical energy storage cell in terms of the invention is understood to mean a structural element which is also capable of converting electrical current supplied by means of electrochemical conversion processes into chemical energy and to store the same, at least temporarily, as well as to pass the stored chemical energy as an electrical current on to a consumer. A film layer in terms of the invention is understood to mean a component layer consisting at least substantially of a film, and a film layer structure in terms of the invention is understood to mean a film-type structure or a structure processable as a film, which consists of several and possibly different film layers. A cavity in terms of the invention is understood to mean a space between two film layers or film layer structures, independently of the actual distances of the film layers or film layer structures from one another. It is understood that a film layer or film layer structure has a certain intrinsic stiffness and stability so that components manufactured therefrom do not collapse or sink down under their own weight. A thickness of a film layer or film layer structure may be several ten to several hundred μm (micrometres).

Using the described aspect of the invention a cooling element has been created which is actively cooled. This also means that a high cooling output is possible. Active cooling of each cooling element also permits accurate and targeted cooling of the entire storage cell stack in the plane of individual storage cells of a stacked array of storage cells. Processing of films is technically easy to control and efficient; the films can be easily deformed, for example by pressing or deep-drawing of relief structures or punching of recesses and holes. Only two individual components (i.e. the film layers or film layer structures) need to be handled in the heat exchanger structure. There is no conflict with the wording of the invention if the two film layers or film layer structures are connected at one edge or are folded over one another; in such a case in fact there exists only one component to be handled.

In a preferred embodiment of the invention the cooling is designed such that the cavity walls formed by the film layers or film layer structures exhibit an elasticity such that in one operating state, in which the heat exchanger structure is under operating overpressure from the heat transfer medium, they expand compared to a depressurised state in thickness direction of the cooling element. Operating overpressure in terms of the invention is understood to mean a pressure difference between the heat transfer medium inside the cavities of the cooling element and an environment which arises when the cooling element is used within design-conforming operating parameters of the cooling element. Wall elasticity in terms of the invention is understood to mean an elastic stretchability in surface-parallel direction of the walls. The configuration described permits the cooling element to be easily mounted between two surfaces to be cooled without having to touch those surfaces. In the described operating state the heat exchanger structure can expand in such a way that its walls come to rest against the surfaces thus ensuring good heat transfer. There is nevertheless no conflict with the wording of the invention if the cooling element is mounted in close contact, possibly even under pressure, between surfaces to be cooled; in such a case the heat exchanger structure will elastically deform during assembly and mould itself against the surfaces, moulding itself further against the surfaces when under operating overpressure and thus further improving heat transfer.

Additionally or alternatively the cooling element may be designed such that the heat exchanger structure comprises expanding portions which will expand in an operating state, in which the heat exchanger structure is under operating overpressure from the heat transfer medium, compared to a depressurised state in thickness direction of the cooling element. Expanding portion in terms of the invention is understood to mean a portion which renders the heat exchanger structure expandable in thickness direction. This expansion is understood to be independent of a material expansion in terms of the above-described elasticity and may be due solely to a corresponding shaping of the walls, such as shaping them in the form of an S or a bellows.

Especially preferably the cooling is designed in such a way that the cooling element comprises a frame structure within which the heat exchanger structure is disposed. Frame structure in terms of the invention is understood to mean a structure which imparts further stiffness to the cooling element in addition to the intrinsic stiffness of the heat exchanger structure, in that it retains the heat exchanger structure within its edge region. In particular the frame structure may define outer dimensions of the cooling element which are independent of an operating overpressure. As such the frame structure may specify, in particular, a defined reference thickness of the cooling element. In this way also the mechanical load-bearing capacity and stability of the cooling element may be increased, and modularisation of a stacked design of, for example but not exclusively, a battery array with cooling elements can be made easier.

Alternatively the frame structure may, at least substantially, be formed of two film layers or film layer structures the opposing surfaces of which are placed against one another. This is an easy way of constructing a symmetrical frame structure. As already mentioned the processing of films is technically easy to control and efficient; only two individual components (i.e. the film layers or film layer structures) as well as the heat exchanger structure to be retained by the frame structure need to be handled. The film layer structures may be constructed from folded film layers in order to achieve a sufficient stiffness. Preferably edge regions of the film layers or film layer structures of the heat exchanger structure may be received between parts of the frame structure. Therefore it cannot be ruled out that an edge region of the film layers or film layer structures from which the heat exchanger structure is formed is understood to be a part of the frame structure.

If the frame structure is formed of folded edge portions of film layers or film layer structures of the heat exchanger structure, manufacture of the cooling element may be simplified even further.

Alternatively the frame structure may be sprayed onto edge portions of the film layers or film layer structures of the heat exchanger structure and stuck on as a moulding or be applied in other ways.

A further developed embodiment may provide for a frame structure comprising a stiffening structure, in particular comprising a number of ribs. Using a construction of this kind sufficient stiffness and stability of the cooling element may again be realised in conjunction with a lightweight construction.

In a preferred embodiment the cooling element is designed such that the heat exchanger structure, in an operating state in which it is under operating overpressure from the heat transfer medium, protrudes in thickness direction beyond an expansion defined by the frame structure, wherein in a depressurised state it does not protrude or protrudes distinctly less than in the operating state, beyond the expansion defined by the frame structure or retracts behind the expansion defined by the frame structure. Thus a plurality of geometric general conditions and installation situations can be covered.

Advantageously the cooling element is developed further in such a way as to comprise a heat transfer medium supply connection and a heat transfer medium discharge connection connected with each other via the cavities. This also permits the cooling element to be connected in a simple way with a coolant supply circuit.

In an especially preferred embodiment the cooling element is designed such that the cavities, at least in one portion of the heat exchanger structure, form one or more channels which preferably extend in parallel to one another and which allow the through-flow of the heat transfer medium in the same direction or the opposite direction. Thus a plurality of thermal design parameters can be covered.

It has proved to be advantageous if the film layers or film layer structures comprise a plastic. The plastic may comprise, in particular but not exclusively, an elastomer such as PE, PC, PP, PVC, PS. An elastomer (or thermoplastic) in terms of both the invention and in general terms is understood to mean a plastic which is reversibly deformable within a certain temperature range. The film layers or film layer structures may also comprise a composite film, a laminate film or the like in order to map different material properties, for example. Preferably the film layers or film layer structures may contain a material influencing thermal conductivity. Such materials are for example, but not exclusively, quartz powder, glass, metals, aluminium nitride powder or carbon.

Especially preferably the heat transfer medium is a liquid heat transfer medium which preferably comprises one of water and an alcohol, in particular glycol, especially preferably in a mixing ratio of at least approximately 50:50. Such a mixture can absorb a good deal of heat on the one hand and on the other is well protected against freezing. Depending on ambient temperature and other requirements the mixing ratio can be adapted and/or further additives can be mixed in.

According to a further aspect of the invention a method for manufacturing a cooling element to be disposed in particular between flat sides of two electrochemical energy storage cells, comprises the steps of:
preparing a first film layer or film layer structure and a second film layer or film layer structure, preferably of a plastic material;
disposing the first and second film layers or film layer structures such that surfaces of the first and second film layers or film layer structures are facing each other; and
connecting the first and second film layers or film layer structures at the junctures formed in the surfaces such that a cavity structure is formed between the junctures, which is preferably open on the edge in at least two places, wherein a through-connection exists between the two open places in order to form a heat exchanger structure.

Especially preferably the step of preparing comprises a step of forming a relief structure in the first and second film layers or film layer structures, wherein the relief structure following the step of connecting the first and second film layers or film layer structures forms the cavity structure.

Alternatively or additionally the method comprises a step of introducing a pressure fluid between the first and second film layers or film layer structures, preferably in a heated state, in order to widen the cavity structure, especially preferably with the aid of a matrix in order to limit widening.

Especially preferably the method comprises a step of forming a frame structure extending at least substantially circumferentially around the edge on both sides of a dividing plane defined between the first and second films.

According to a further aspect of the present invention an electrochemical energy storage device comprises a plurality of, in particular flat, electrochemical energy storage cells which are arranged in a stack with their flat sides facing one another, wherein a cooling element is disposed between respectively two storage cells, which cooling element is designed as described above or is manufactured according to the above-described method. With this arrangement heat transfer medium supply connections and heat transfer medium discharge connections of the cooling elements in the electrical energy storage device are all respectively connected with a heat transfer medium supply circuit. If a cooling element is disposed between respectively two storage cells, efficient cooling can be realised. Using active cooling of the described cooling elements accurate and targeted cooling of the storage cell stack is possible.

### SHORT DESCRIPTION OF THE DRAWINGS

The above-described and further features, requirements and advantages of the present invention will become clearer from the following description prepared with reference to the attached drawings.

In the drawings:

FIG. 1 is perspective illustration of two battery cells with a cooling element in an embodiment of the present invention;

FIG. 2 is a perspective illustration of the cooling element alone;

FIG. 3 is a frontal view of the cooling element;

FIG. 4 is a side view of the edge of the cooling element along line IV-IV in viewing direction of associated arrows in FIG. 3;

FIG. 5 is an enlarged sectional view of a detail of the cooling element along line V-V in viewing direction of associated arrows in FIG. 3;

FIG. 6 is a schematic sectional view of a test body for illustrating processes of thermal through-flow;

FIG. 7 is a schematic frontal view of a cooling element in a variant of the embodiment of the present invention;

FIG. 8 is a schematic frontal view of a cooling element in a further variant of the embodiment of the present invention;

FIG. 9 is an enlarged sectional view of FIG. 5 showing a modification in the construction of the cooling element;

FIG. 10 is an enlarged sectional view of FIG. 5 showing a further modification in the construction of the cooling element;

FIG. 11 and FIG. 12 are enlarged sectional views showing a further modification in the construction of the cooling element in two manufacturing stages;

FIG. 13 is a top view of a semi-finished product for manufacturing a cooling element according to FIG. 11 or FIG. 12; and

FIG. 14 is a schematic illustration of a battery cell array with a coolant circuit.

It is pointed out that the illustrations in the figures are schematic and limited to showing the features most important for understanding the invention. It is also pointed out that the dimensions and sizes given in the figures only serve the purpose of clarifying the illustration and are not to be understood as in any way limiting, unless something different is stated in the description. In the following description of a preferred embodiment and its variants and modifications identical or analogue components have been labelled with identical or similar reference symbols.

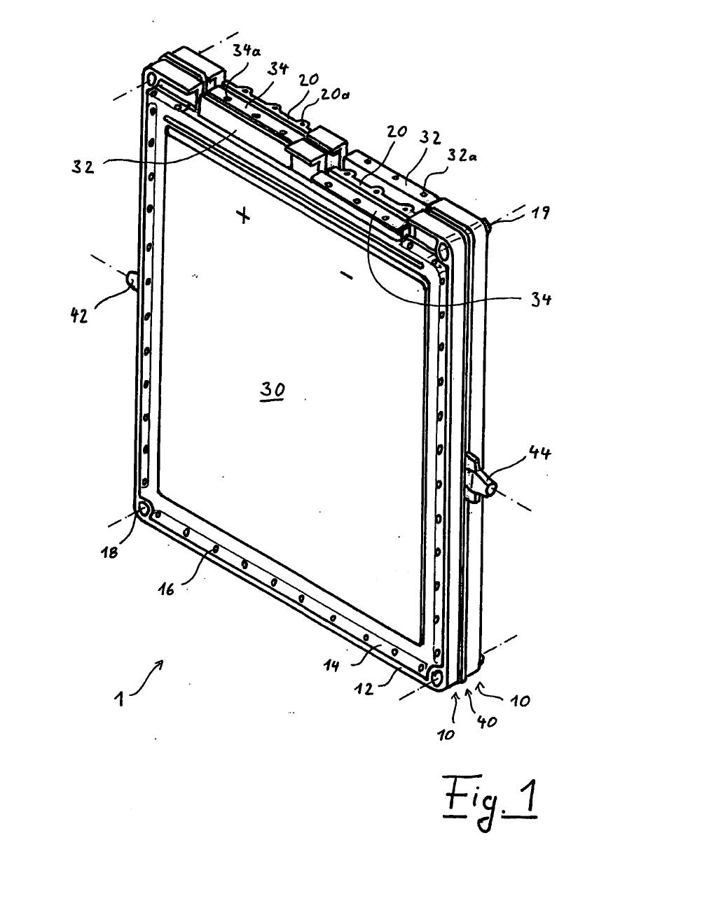

FIG. 1 in a battery array 1 shows two lithium-ion battery cells 10 with a cooling element 40 disposed in between, in a perspective view. The two battery cells 10 are components of a block or module of battery cells 10 in which two or more battery cells 10 may be stacked and which are an example for electrochemical energy storage cells in terms of the invention. In the block the battery cells 10 are connected in series and/or in parallel in such a way that a predetermined block voltage and block capacity is realised on the basis of individual voltages and individual capacities of battery cells 10. The exact construction of the battery cells 10 substantially follows the subject of a patent application not yet published at the time of submitting the present application and which is kept under internal reference number no. 106876 at the applicant's representative and insofar is referenced to its full extent, and the construction is therefore described only to the extent necessary for understanding the invention.

According to the illustration in FIG. 1 a battery cell 10 comprises a battery element 30 and a two-part frame with two frame parts 12, 14, wherein the first frame part 12 has a trough shape with a circumferential edge stay and the second frame part 14 has a plate shape and is fitted into the edge stay of the first frame part 12. Elevations or pins (not shown in detail) standing out from a bottom of the first frame part 12 engage in holes 16 of the second frame part 14. Four depressions 18 are provided at the four corners of the first frame part, at which the edge stay widens. Four knobs 19 aligned with depressions 18 are moulded to the back of the first frame part. It should be noted that the depression depth of depressions 18 is greater than the height of knobs 19 plus a thickness of the cooling element 40, and that when several battery cells 10 are assembled together the knobs 19 of a battery cell 10 can be respectively accommodated in the depressions 18 of an adjacent battery cell 10. Mounting holes (not shown in detail) are formed in frame part 12 which are aligned with depressions 18 and knobs 19. After the required number of battery cells 10 has been strung together with cooling elements 40, they can be screwed together by means of long screws (not shown in detail) extending through the mounting holes.

Battery element 30 shows the form and the construction of a pouch cell (coffee bag cell) the edge of which is clamped between the bottom of the first frame part 12 and the second frame part 14. On the top of battery cell 10 a positive conductor 32 and a negative conductor 34 of the battery element 30 are exposed in corresponding notches of the first frame part 32. A pouch cell is understood to be a battery element, where a sequence of electrode-, current collector- and separator-films are arranged in a stack or a flatpack winding and form a flat packet. The electrode films comprise films which act as an anode and films which act as a cathode, and they are respectively connected with a current collector film. The current collector films of the anodes are joined together, in particular outside the stack or winding, and connected with the negative conductor 34; similarly the current collector films of the cathodes are joined together, in particular outside the stack or winding, and connected with the positive conductor 32. The entire stack or winding of the films including an area, where the current collector films are joined together, is enveloped in the manner of a sandwich by a barrier film which forms a circumferential edge (also called sealing seam) and tightly enclosed. The conductors 32, 34 protrude through the sealing seam to the outside. For the purposes of this application the term battery is used in particular, but not exclusively, for secondary batteries, i.e. for several times dischargeable and rechargeable batteries, also called accumulators. The battery elements 30 are assumed to be lithium-ion or lithium-polymer accumulator elements or the like; the invention is, however, not limited to battery elements of this kind.

The positive conductor 32 is bent at right angles and comprises several (here three) holes 32a in the angled arm; similarly the negative conductor 34 is bent at right angels and comprises several (here three) holes 34a in the angled arm. Inside the notches of the first frame part 12 bearings 20 are formed the height of which corresponds to the height of the angled arms of conductors 32, 34. The bearings 20 further comprise several (here three) holes 20a which correspond to the holes 32a, 34a of conductors 32, 34. In two adjacent battery cells 10 the battery elements 30 are arranged in their frames 12, 14 in such a way that the angled arms of conductors 32, 34 to be connected lie on top of each other and whose holes 32a, 34a are aligned with each other and with the holes 20a of bearings 20. The conductors 32, 34 can be fixed on bearings 20 by means of screws (not shown in detail) screwed through holes 32a, 34a into holes 20a of bearing 20, and can be reliably contacted with each other.

As shown in FIG. 1 a cooling element 40 is disposed between two battery cells 10. The cooling element 40 is an active cooling element, i.e. a coolant flows through it. It comprises a flow connection 42 and a return connection 44 which protrude laterally from the array.

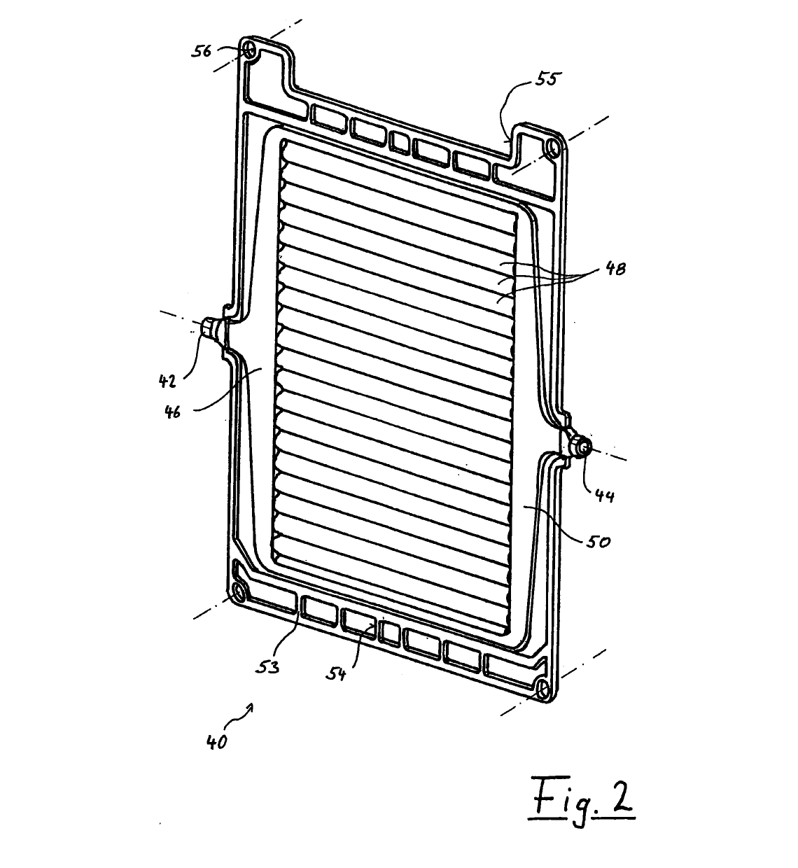

The cooling element 40 of FIG. 1 is shown on its own in FIG. 2 According to the illustration in FIG. 2 the flow connection 42 is connected with a manifold channel 46. The manifold channel 46 ends in, or branches to become, a plurality of parallel heat exchanger channels 48 which in turn end in a collecting channel 50 connected with the return connection 44.

The flow connection 42 and the return connection 44 comprise a substantially annular orifice which can be respectively connected with a flow manifold and a return manifold (not shown in detail) of the battery. The flow connection 42 and the return connection 44 may, for example, comprise a male thread or a shape which permits a connection created by pinching or the like. Other types of connection such as a conical fit or the like is also feasible.

The above-described partial elements of cooling element 40, i.e. the flow connection 42, the manifold channel 46, the heat exchanger channels 48, the collector channel 50 and the return connection 44 together form a heat exchanger structure (without separate reference symbol) in terms of the invention, which is retained in a frame 52. Frame 52, on the one hand, serves to stabilise the heat exchanger arrangement and, on the other hand, to achieve a dimensionally accurate disposal between battery cells 10. In order to save weight, frame 52 comprises several recesses 54, insofar as permitted by the demands on the overall stability (accordingly ribs 53 remain standing between recesses 54). The remaining surfaces of the frontal faces (flat sides) of the frame 52 form contact surfaces for the frame elements 12 of battery cells 10, as shown in FIG. 1.

In the upper part of cooling element 40 a bay 55 is formed, the dimensions of which roughly correspond to recesses in the frame parts 12 of battery element 10 for receiving conductors 32, 34. Bores 56 in the corners of frame 52 of cooling element 40 are, when assembled, aligned with knobs 19 of frame elements 12 and have a corresponding diameter. Knobs 19 whose axial extent is greater than the thickness of frame 52 of cooling element 40 also serve as an assembly aid for cooling element 40 as well as the next battery cell 10. Given a sufficiently narrow toleration of the diameters and positional distances of depressions 18 and knobs 19 on the side of frame element 12 of battery cell 10 and bores 56 on the side of frame 52 of cooling element 40, a tightly held block of battery cells 10 and cooling elements 40 can be formed, which at least in a partially assembled state holds together even without tensioning screws; this can make handling considerably easier during assembly.

The heat exchanger channels 48 (FIG. 1) are designed such that when in a depressurised state they do not protrude in thickness direction beyond frame 52 and exhibit an elasticity such when under internal pressure corresponding to an operating state with introduced coolant, they expand in cross-section so that in thickness direction they protrude beyond the limitation of frame 52. This expansion ensures that the heat exchanger channels 48 in operation mould themselves against the battery element 30. This has the effect of distinctly reducing the transfer resistance since irregularities are evened out and an air gap is reduced (ideally disappears) resulting in a satisfactory heat transfer. Compared to conductor cooling the cooling path is distinctly shortened.

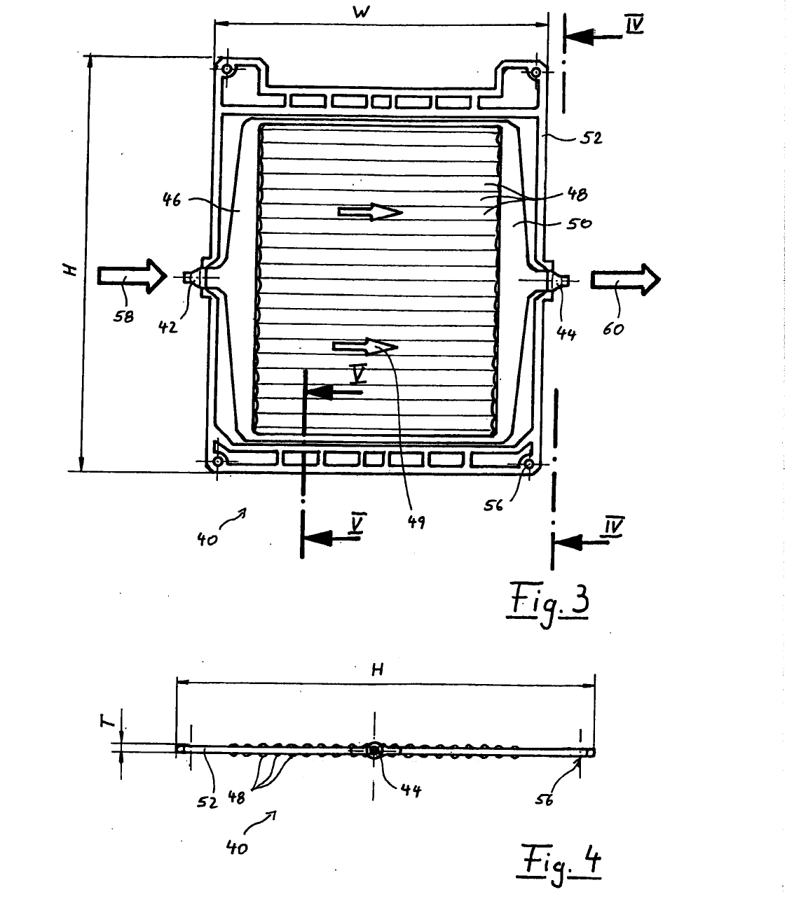

FIG. 3 shows a frontal view of cooling element 40; and FIG. 4 shows a side view of cooling element 40 in viewing direction of an arrow IV in FIG. 3 in a pressurised state.

FIG. 3 schematically indicates a coolant flow (cold) 58 and coolant return (hot) 60. The main dimensions (width W, height H) of cooling element 40 are also shown. For a typical battery element (lithium-accumulator cell) of 40 Ah the width W of the heating element (and one battery element) may, for example, be approx. 220 mm and the height H of the heating element (and one battery element) may, for example, be approx. 276 mm.

FIG. 4 shows a side view of heating element 4 viewed from the side of return connection 46. In the figure thickness T of frame 52 is shown as the third main dimension of cooling element 40.

The thickness T of heating element 40, in a practical implementation of a lithium-ion-battery cell of 40 Ah, may for example be 2 to 3 mm (the direction of thickness T of cooling element 40 is also called thickness direction in terms of the invention). According to the illustration in FIG. 4 the heat exchanger channels 48 (this part is also called cooling path), in the pressurised state shown here, protrude in thickness direction beyond the limitation of frame 52, as mentioned above.

The coolant used (flow 58/return 60) may for example be a mixture of water and glycol in a ratio of 50:50. The mixing ratio may be adapted to suit the climatic conditions. It is understood that depending on capacity, construction and other general conditions other dimensions may be required, and the measurements cited here are only given as an example and in no way represent a limitation of the inventive idea.

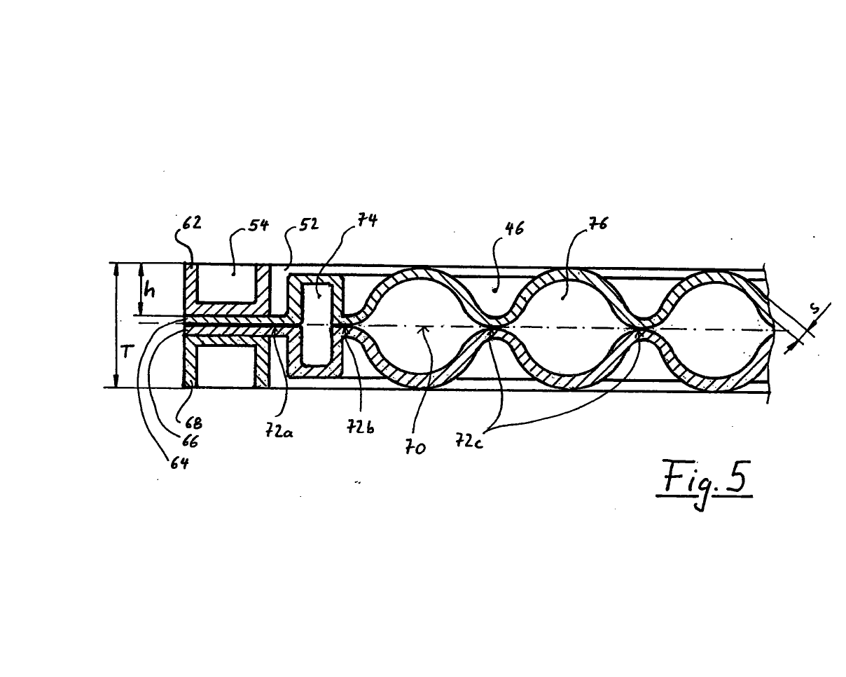

FIG. 5 shows an enlarged sectional view of the cooling element along a line and in viewing direction of an arrow V in FIG. 3; the figure illustrates the internal construction of cooling element 40.

According to the illustration in FIG. 5 the cooling element 40 is essentially composed of four layers. The first layer 62 forms a first frame half 62, the second layer 64 forms a first heat exchanger half 64, the third layer 66 forms a second heat exchanger half 66 and the fourth layer 68 forms a second frame half 68. A chain-dotted line 70 in the figure indicates a symmetry plane of the layer construction.

The second and third layers 64, 66 are manufactured from films and connected with each other at junctures 72a, 72b, 72c, by welding or gluing, for example. Cavities 74, 76 are formed between junctures 72a, 72b, 72c. In the cut-out shown cavity 74 represents a connection between the manifold channel 46 and the collector channel 50 (FIG. 2), and the cavities 76 represent the heat exchanger channels 48 (FIG. 2) of cooling element 40. In the background of the figure manifold channel 46 is visible. The manifold channel 46 and the collector channel 50 (FIG. 2) are delimited by similar junctures.

During manufacturing heat exchanger halves 64, 66 can shaped in advance (for example by deep-drawing or hot pressing and then connected at the junctures 72a, 72b, 72c. Alternatively the layers 64, 66 can first be connected at junctures 72a, 72b, 72c (such as by the action of heat) and then progressively formed when hot under pressure by means of a matrix, as required.

In the edge region of the second and third layers 64, 66 the first and fourth layers (first and second frame halves) 62, 68 are welded on, sprayed on or moulded on in other ways above and below the symmetry plane 70, respectively. These form a circumferential frame (frame 52, FIG. 2) for stiffening the assembly of the second and third layers 64, 66. (From a mechanical point of view the edge regions of the heat exchanger halves 64, 66 received between the two frame halves 62, 68 may also be regarded as part of frame 52.) Frame 52 is a frame structure in terms of the invention and the two heat exchanger halves 64, 66 within the frame 52 form the heat exchanger structure in terms of the invention. The entire region within frame 52 in which the heat exchanger structure is disposed is also called a cut-out of the frame structure in terms of the invention.

The shape of frame halves 62, 68 with recesses 54 may, for example, be manufactured by deep-drawing or hot pressing of thin film. Alternatively the recesses 54 may be formed, for example, by subsequent pressing-in, evaporating (such as by laser beam) or by milling in case of a thicker material layer.

The heat exchanger halves 64, 66 have a corrugated cross-section in the region of cavities 76 (of heat exchanger channels 48). The film, from which the heat exchanger halves (layers) 64, 66 are manufactured is sufficiently elastic for the corrugations to stretch when there is internal pressure in the cavities 76 in thickness direction of the cooling element 40 with the effect that they protrude beyond the limitation of edge 52. As shown in FIG. 5 the manifold channel 46 has a lesser extension in thickness direction; the same is true of the collector channel (50, see FIG. 2) not visible in the figure. The manifold channel 46 and the collector channel 50 therefore do not expand as much under overpressure in thickness direction as do the heat exchanger channels 48.

Layers 62, 64, 66, 68 are, for example, formed from films of a plastic; they form, in particular, film layers or film layer structures in terms of the invention. The material of layers 62, 64, 66, 68 is selected according to the required chemical stability, fire behaviour (B1 etc.), input temperature, thermal conductivity, thermal resistance, wear and tear resistance and the like. Especially preferably the films are comprised of an elastomer such as polyethylene (PE), polycarbonate (PC), polypropylene (PP), polyvinylchloride (PVC), polystyrene (PS) or comparable thermoplastics. In order to improve thermal conductivity substances such as quartz powder, glass, metals, aluminium nitride powder, carbon or other substances can be added. The layers 62, 64, 66, 68 can also be manufactured from a composite film, a laminate film or the like. With such composite films one layer may have a property improving toughness or tear resistance, such as through the use of fibre-reinforces plastics. As a guide, if the height h of a frame half 62, 68 is about 1 mm to 1.5 mm for example, the thickness s of the two inner films 64, 66 may each be about 50 μm to 150 μm. As such the overall thickness T of frame 52 may, for example, be 2.1 mm to 3.3 mm.

A simplification of the manufacturing process may be achieved in that the film layer of the heat exchanger structure (the first and second heat exchanger halves 64, 66) are contiguous on one edge and can be folded one over the other for connection.

The film thickness s is of essential influence on the heat transfer in the region of the heat exchanger channels 48.

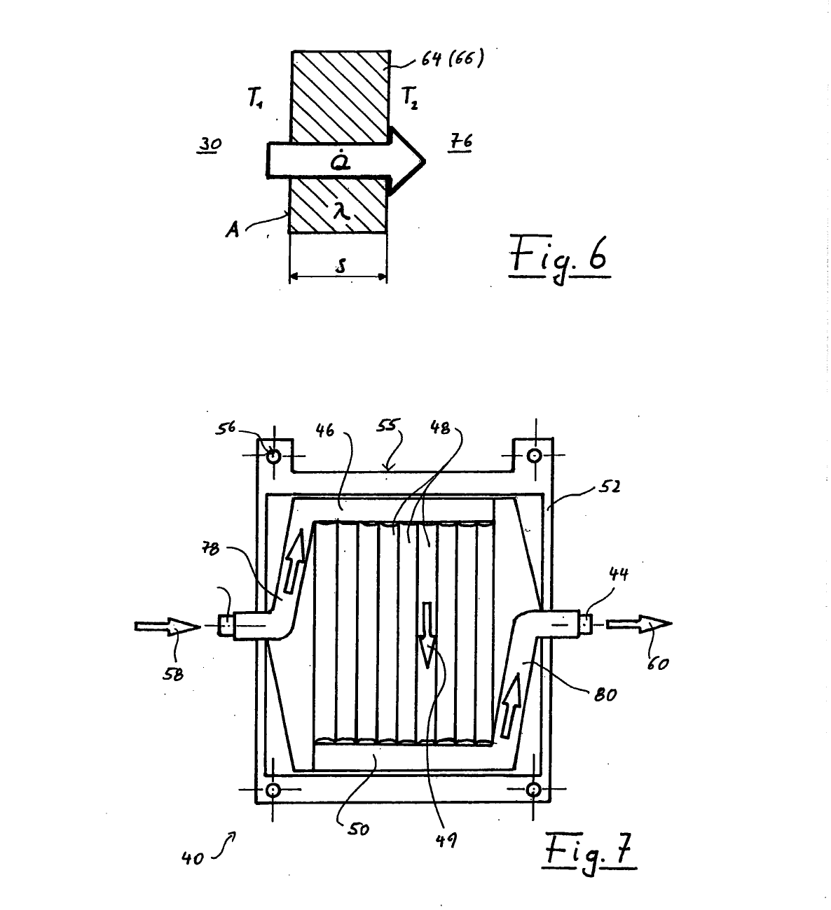

FIG. 6 shows a heat transfer from a battery element 30 through the wall (layer 64 or 66) into the cavity 76 of a heat exchanger channel 48. Symbol T₁ symbolises a temperature of battery element 30 in [K], T₂ symbolises a temperature of a heat transfer medium inside cavity 76 in [K], A symbolises a contact surface in [mm²], s symbolises the thickness of layer 64 (66) in [m], Q symbolises a thermal current in [J/s] and λ symbolises the thermal conductivity of layer 64 (66) in [W/K*m] or [J/K*m*s].

The unit for thermal conductivity shows that the layer thickness is of substantial influence on the absolute heat conductance. Therein λ always refers to a unit model indicating the amount of heat Q (in [J]) which flows within one second (1 s) through a layer with an entry surface of A=1 m² with a thickness of 1 m. When T₁ is the entry temperature and T₂ the exit temperature the thermal current results in

$$\dot{Q} = \frac{λ}{s} \times A \times ( {T}_{1} - {T}_{2} ) . \qquad ( 1 )$$

The battery element 30 may be interpreted as a heating element for this discussion, and the thermal current Q, assuming stationary conditions, may be interpreted as heating output of the heating element.

Given known geometric quantities, a known entry temperature T₁ and a known heating output Q, the exit temperature T₂ (temperature on the back of the film) for ideal conditions may be calculated using the following formula (2)

$${T}_{2} = {T}_{1} + \frac{\dot{Q} \times s}{λ \times A} \qquad ( 2 )$$

which results from the previous formula (1) by a simple rearrangement.

In order transfer typical conditions of a battery cell (a Li-ion accumulator cell of 40 Ah may be considered as an example) to the above model, a battery element 30 may be assumed to be a heating element with a heating output Q of 30 W (J/s). A typical heat conducting coefficient λ of a plastic film is assumed to be 0.6 W/K*m, and a surface of 0.2×0.2 m² is assumed to be the contact surface. For a constant entry temperature T₁ of 50° C. the exit temperature shall be ascertained for ideal conditions (since only differences in temperature are considered or temperature constants are minimised in the underlying formula, it is admissible to calculate in [K] instead of in [° C.]). The following table 1 contains the calculation results for different layer thicknesses s.

TABLE 1

| Schlchtdickes in mm | T1 | T2 | Lambda | Wärmelelstung | Fläche m² | delta T |
|---|---|---|---|---|---|---|
| 0.15 | 50 | 49.8125 | 0.6 | 30 | 0.04 | 0.1875 |
| 0.3 | 50 | 49.625 | 0.6 | 30 | 0.04 | 0.375 |
| 0.5 | 50 | 49.375 | 0.6 | 30 | 0.04 | 0.625 |
| 1 | 50 | 48.75 | 0.6 | 30 | 0.04 | 1.25 |
| 2 | 50 | 47.5 | 0.6 | 30 | 0.04 | 2.5 |
| 3 | 50 | 45.25 | 0.6 | 30 | 0.04 | 3.75 |
| 4 | 50 | 45 | 0.6 | 30 | 0.04 | 5 |

It can be seen that for a heating output of 30 W and a surface of 0.04 m² for small layer thicknesses the effects of the Lambda value are visible only in the area after the comma.

In this context it is pointed out that the film layers for forming the heating exchanger structure (heat exchanger halves 64, 66) may be thinner in the region of the arches than in the region of the junctures. This thinning which may be created for example by a forming process during forming the cavities 76 may be desirable as regards elasticity and heat transfer.

FIG. 7 shows a variant of cooling element 40 of the present invention in a simplified illustration, wherein the view corresponds to that of FIG. 3.

In the above embodiment according to the illustrations in FIGS. 2 and 3, the current channel initially widens vertically to the current direction in flow connection 42 and then disperses into heat exchanger channels 48, which extend vertically like teeth of a comb from flow connection 42 and end vertically in collector channel 50. The current direction in the heat exchanger channels 48 (indicated by arrows 49 in FIG. 3) corresponds to the inflow and outflow directions (58, 60). In a modification of a cooling element 40 as per FIG. 7 the current coming from flow connection 42 is initially guided to the top of cooling element 40, where a manifold channel 46 extends in width direction of cooling element 40. At the bottom of cooling element 40 a collector channel 50 correspondingly extends in width direction of cooling element 40. The collector channel 50 is connected with return connection 44 by a further connecting channel 80. Several heat exchanger pipes 48 extend between the manifold channel 46 and the collector channel 50, and the current direction through the heat exchanger pipes 48 (indicated by arrows 49) extends vertically from top to bottom, i.e. transversely to the flow and return directions 58, 60.

In a further variant the manifold channel 46 may be arranged at the bottom and the collector channel 50 may be arranged at the top so that the current direction 49 in the heat exchanger channels point upwards.

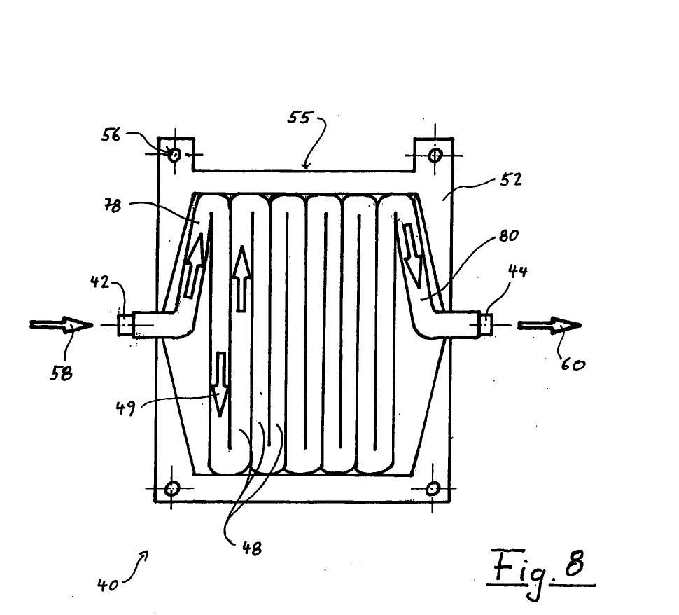

FIG. 8 shows a further variant of cooling element 40 in an illustration corresponding to that of FIG. 7. In the present variant a single heat exchanger through-channel 48 extends in a zigzag shape (see arrows 49).

It will be obvious to the expert that further variants regarding current channels (heat exchanger channels) can be formed for realising an i-flow, U-flow or S-flow heat exchanger element.

According to the shown embodiment the corrugated cross-section of the heat exchanger halves 64, 66 may be composed of circular ring elements. Deviations from this are possible. As such the corrugations may be stretched higher and thus comprise an egg-like cross-sectional shape, or they may be stretched wider and thus comprise an elliptical cross-sectional shape. In a further alternative the corrugations may comprise a rounded-angled shape.

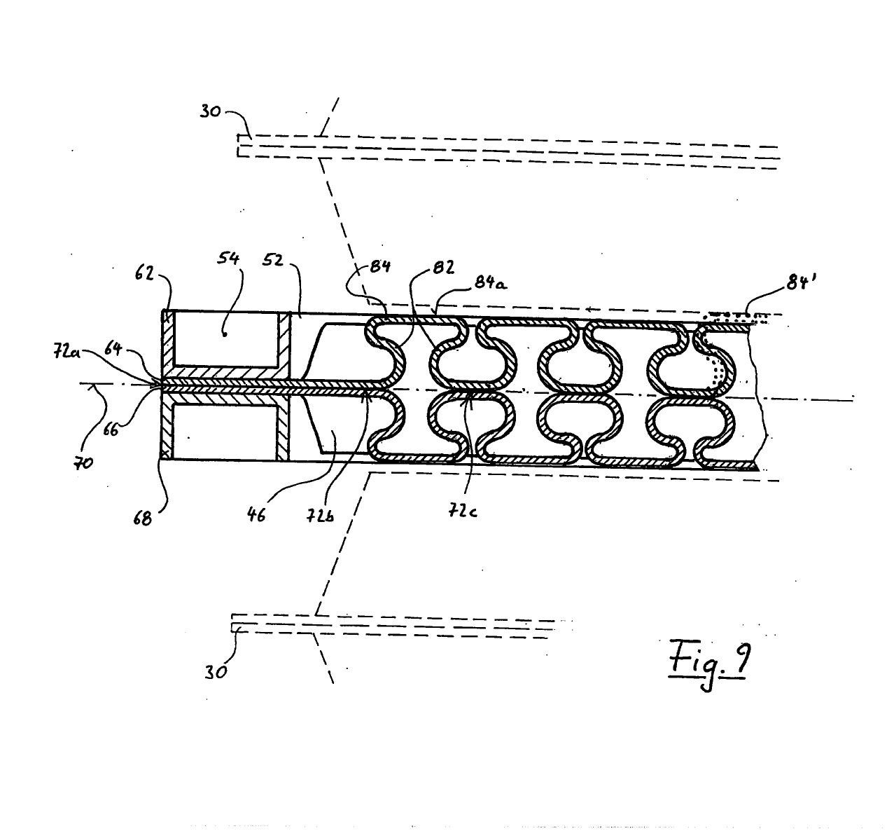

FIG. 9 shows a view corresponding to the enlarged part-sectional view of FIG. 5 which shows a modified construction of the heat exchanger structure, in particular of the cavities 76 for forming the heat exchanger channels 48. Outlines of adjacent battery elements 30 are shown as broken lines. Insofar as nothing different is expressly or imperatively revealed the statements regarding the previous embodiments and variants are to be applied to the present variant.

According to the illustration in FIG. 9 the portion of heat exchanger halves 64, 66 which form the walls of cavities 76 for forming the heat exchanger channels 48 respectively comprise stay portions 82 and a moulding portion 84 connecting the stay portions, in order to form a cavity 76 closed in cross-section. It should be noted that cavity 74 (FIG. 5) has been omitted in this variant.

The moulding portions 84 comprise an outer surface 84a which is at least substantially planar and extends in parallel to the symmetry plane 70. The moulding portions 84 are thus designed and adapted to mould themselves against an outer contour of battery elements 30. Due to the planar and (compared to the embodiment of FIG. 5) wider outer surface 84a the heat transfer surface 30 can be enlarged with the battery element 30.

The stay portions 82 extending from the symmetry plane 70 in direction of the moulding portion 84, comprise a s-shaped bent progression in cross-section. In one operating state in which channels 48 are under operating overpressure from the coolant, the stay portions 82 extend such that the moulding portions 84 come to rest against the battery elements 30 (see dotted contour 84′ in the upper half of the cavity shown on the right). The stay portions 82 thus form expanding portions in terms of the invention.

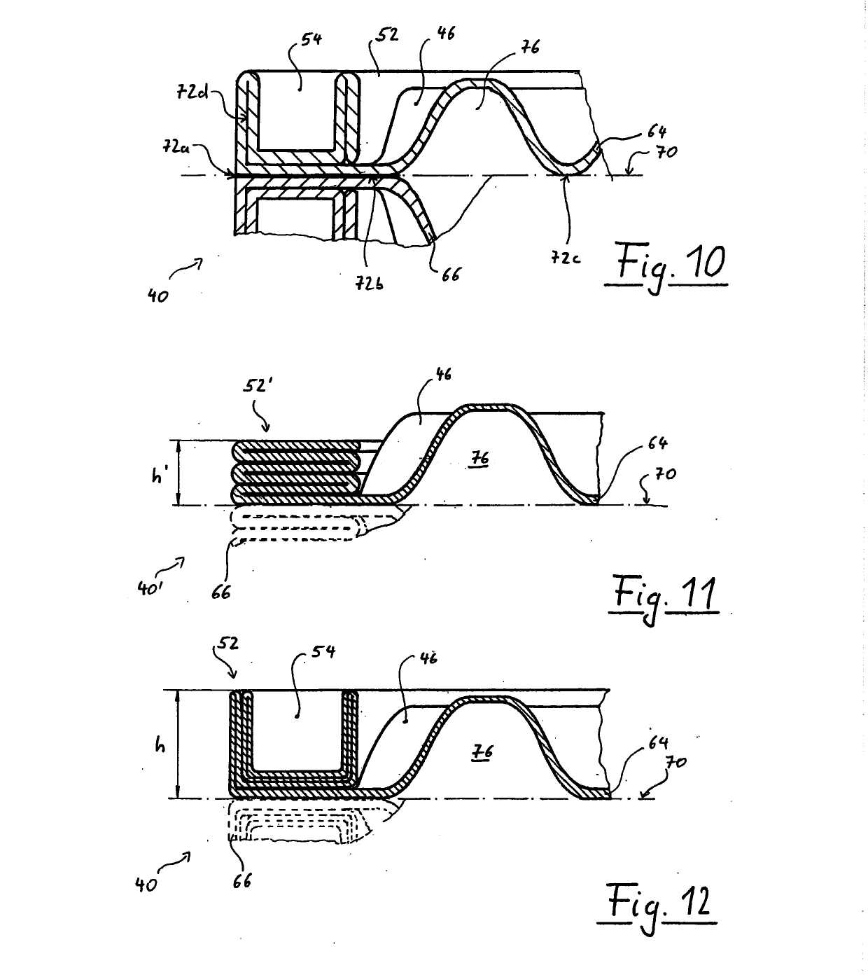

FIG. 10 shows a further variant of the embodiment of the present invention. The variant relates substantially to the layer assembly of cooling element 40.

The cooling element 40 in this variant is constructed in the main of only two layers 64, 66. Layers 64, 66 form heat exchanger halves as in the above-described embodiment with cavities 76. The frame 52 is also formed of these layers 64, 66. Therein edge regions of layers 64, 66 are folded in form of a “U” in order to obtain a circumferential double U-shaped frame 52, which is formed on both sides of the symmetry plane 70 from respectively two folds of layers 64 or 66, whilst the walls of cavities 76 are formed of only one fold of layer 64 or 66. The layers 64 and 66 in the region of the edge profile comprise a common connecting layer or juncture 72d, where they are connected with each other by gluing, welding or the like.

It should be noted that the “U” profile of edge 52 of this variant corresponds to recesses 54 in FIG. 2 etc. When bores 56 (FIG. 2) are bored in the corners of frame 52 it will be found that the material is very thin in this variant. Additional support may be provided at the corners of frame 52 in the form of further film material or even in the form of solid material. In addition additional transverse ribs may be provided in order to reinforce the frame.

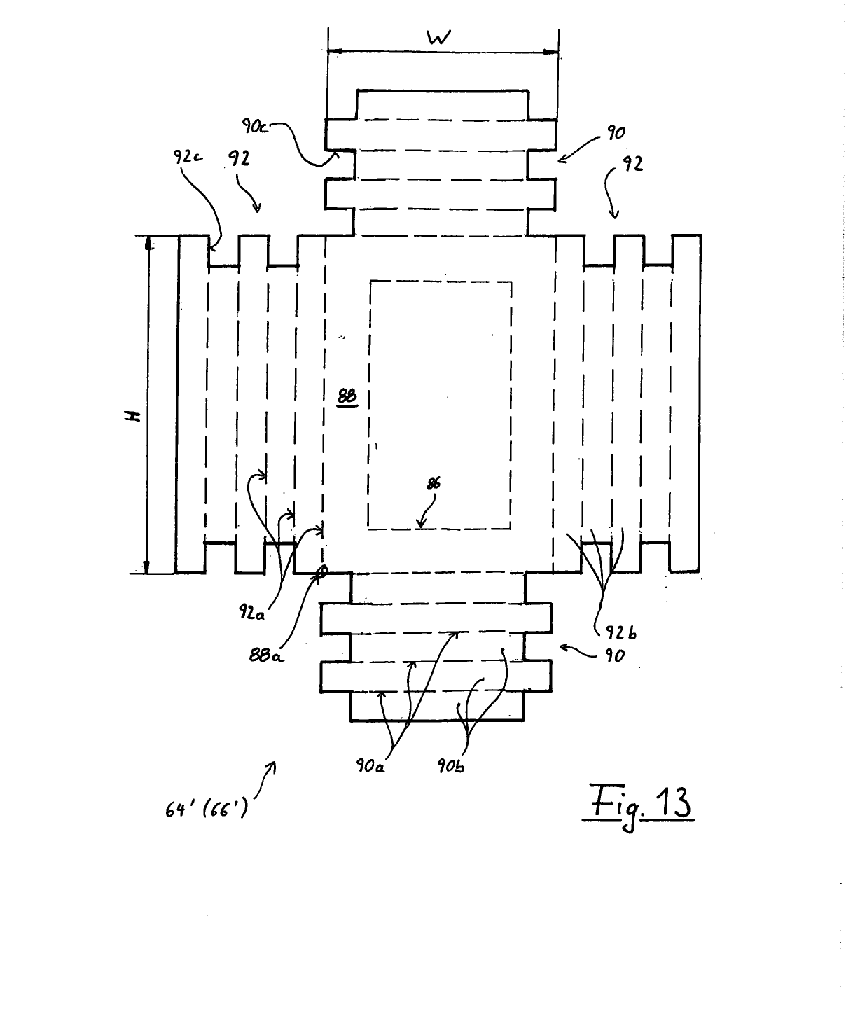

FIGS. 11 and 12 show two method steps during manufacture of a cooling element 40 in a further variant of the embodiment of the present invention.

The cooling element 40 in this variant is, as in the previous variant, formed substantially of two layers 64, 66. The layers 66, 66 form heat exchanger halves with cavities 76. Frame 52 is also formed of these layers 64, 66 as will be explained with reference to FIGS. 11 and 12.

In a manufacturing stage 40′ of the cooling element shown in FIG. 11, edge regions of layers 64, 66 are folded several times on both sides of the symmetry plane 70 in order to form an edge bead 52′ which circumferentially surrounds the heat exchanger structure (cavities 76 or channels 46, 48, 50) on all sides.

Using a matrix tool (not shown in detail) the edge bead 52′ is then hot-formed (pressed) in order to form edge 52 with its recesses 54, as shown in FIG. 12. As can be seen in FIG. 12 the folds of layer 64 or 66 have become thinner after the pressing process than in the edge bead 52′, at the same time height h of edge 52 has increased in relation to height h′ of edge bead 52′ in the manufacturing state shown in FIG. 11. (Also the layout of the film folds in the region of edge 52 in FIG. 12 is shown very much simplified; in reality the folds are formed into a more complicated geometric pattern by the forming process between in FIGS. 11 and 12.)

In a further variant the edge bead 52′ (formed at the level of the final edge 52 in deviation from FIG. 11, and therefore consisting of more folds) can, for example, be produced by milling instead of pressing in order to form recesses 54.

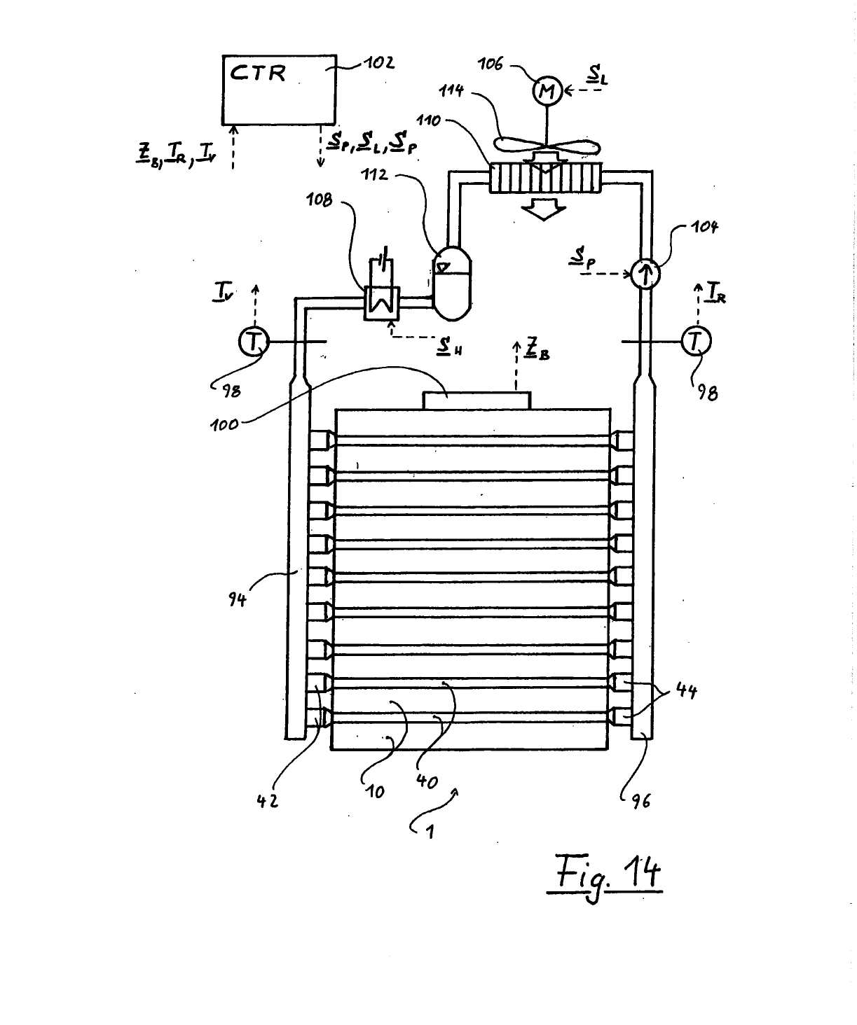

FIG. 13 shows a cut film sheet 64′ or 66′ which is the input material of one heat exchanger half 64 or 66 shown in the variant of FIGS. 11 and 12. Broken line 86 indicates the region which is reserved for a subsequent heat exchanger structure (a relief structure determining the heat exchanger structure, i.e. the cavities 76 etc., has not as yet been formed in the state shown in FIG. 13.) An edge region 88 outside line 86 marks the geometric boundaries of the frame element (width W and height H). The short sides (width W) of edge region 88 are adjacent to flaps 90 respectively, and the longer sides (height H) of edge region 88 are adjacent to flaps 92.

Broken lines 90a, 92a within flaps 90, 92 indicate the bending lines where flaps 90, 92 are to be bent over or to be folded, thereby forming en edge bead 52′ (FIG. 11). Strips 90b, 92b are defined between the bending lines 90a, 90b.

Furthermore flaps 90, 92 comprise lateral incisions 90c, 92c the depth of which corresponds to the distance of bending lines 90a, 92a. On the narrower flaps 90 the first strip 90b comprises incisions 90c, the second strip 90b does not have any incisions, the third strip again comprises incisions 90c, and so on in rotation; whereas on the wider flaps 92 the first strip 92b does not have any incisions, the second strip 92b comprises incision 92c, the third strip does not have any incisions and so on in rotation. Now if wider flaps 92 and narrower flaps 90 are folded alternately, the flaps 90b with incisions 90c meet with strips 92 without incisions at the corners of edge 88, and strips 90b without incisions meet with strips 92 with incisions 92c. In this way material accumulations can be avoided, thereby also avoiding superelevations in the region of corners 88a.

It is understood that the sequence of incisions may be different. What is important with this variant is merely that at the corners 88a where strips 90b, 92b of the same ordinal coincide one strip comprises an incision whilst the other does not.

In a variation of this variant, at a corner 88a, two sequential strips of a flap 90 or 92, respectively, may comprise an incision 90c, 92c, whilst the corresponding strips of the other flap do not comprise an incision. In this variation the intertwining of the flaps 90, 92 is not pronounced, but folding of flaps 90, 92 is easier to accomplish.

It should be noted that in a further variant material accumulations and thus superelevations in the region of corners 88a are tolerated in order to render incisions 90c, 92c unnecessary. With this variation the increased demand in material in the corners 88a can be justified in that the bores 56 (FIG. 2) need to be reinforced.

Furthermore it should be noted that when dimensioning the blank 64′ (66′) an asymmetry for forming bay 55 (FIG. 2) has been disregarded.

FIG. 14 shows a battery array 1 with a cooling circuit of the kind provided in a vehicle, but which is also suitable for a stationary plant.

Battery array 1 in the example shown, without, generally spoken, limiting design and number, comprises ten lithium-ion battery cells 10 according to the above description with cooling elements 40 arranged respectively in between.

The flow connections 42 of cooling elements 40 protruding laterally from battery array 1 are connected with a common flow manifold 94. Similarly the return connections 42 of cooling elements 40 protruding from the other side of battery array 1 are connected with a common return manifold 96. A channel temperature sensor is provided in the pipe leading to the flow manifold 94 and the return manifold 96, respectively, which sensors supply a flow temperature signal T_{V} and a return temperature signal T_{R}. The operating states of battery cells 10 or battery elements (30 not labelled in this instance) therein contained may be recorded using sensors not shown in detail and made available as state signals Z_{B} via a battery control unit (stack control unit). The operating states in particular comprise a cell temperature. The temperature and other operating state signals are supplied via a network (not shown in detail) to a control unit (CTR) 102. The control unit 102 processes the signals supplied to it in order to provide control signal S_{P} for a pump 104, control signal S_{L} for a fan motor and control signal S_{H} for an electrical flow heating device 108.

The Pump 104 arranged downstream of the return manifold 96 keeps a coolant circuit going. The coolant conveyed by pump 104 is directed through a radiator 110 and from there into a compensating reservoir 112. From the compensating reservoir 112 the coolant is withdrawn by the suction effect of pump 104 and initially directed through the flow heating device 108 before being supplied via the flow manifold 94 to the flow connections 42 of cooling elements 40.

In the cooling elements 40 the coolant (which, as described above, consists of water and glycol in a suitable mixing ratio of for example 50:50) absorbs surplus heat from battery cells 10. Cooling of the battery cells 10 may be controlled by controlling pump 104 determining the volume current of the coolant and by controlling fan motor 106 the cooling fan 114 of which passes an air current over the radiator 110. Insofar, such as in cold weather and in particular when starting the battery system, pre-heating of the battery cells 10 is possible by controlling the flow heating device 108. The coolant may therefore be also generally understood as a heat transfer medium in terms of the invention. In terms of the invention the flow connection 42 is a heat transfer medium supply connection and the return connection 44 is a heat transfer medium discharge connection. The cooling circuit thus is a heat transfer medium supply circuit in terms of the invention.

A fine adjustment of the temperature control of individual cells 10 in array 1 is possible, for example, via controllable flow throttle valves (not shown in detail), which are arranged upstream of the flow connections 42 and may be controlled via control device 102.

The coolant circuit can be provided separately and be especially adapted for the battery region; alternately, in a hybrid vehicle, a coolant circuit of a combustion motor may be utilised for this purpose.

Although the present invention has been described above in its essential features with reference to an actual embodiment and its variants, it is understood that the invention is not limited to this embodiment, but can be modified and expanded to the extent and area specified by the patent claims, for example, but not exclusively, in the way indicated below.

In the embodiments and variants described and illustrated the heat exchanger channels 48 are flush with an outer limit of cooling element 40 defined by frame 52 in a depressurised state essentially in thickness direction of cooling element 40, and do not come into contact with respectively adjacent battery elements 10. In variants the outer contour of the heat exchanger channels 48, in a depressurised state, can retract behind the boundary of frame 52 or extend marginally beyond it. The important factor for an optimal functioning of cooling element 40 is that the outer contour of the heat exchanger channels, in an operating state in which the cooling element is under operating over pressure from the heat transfer medium, moulds itself against the battery element 10. In a further variant the outer contour of the heat exchanger channels 48, in the depressurised state, may extend distinctly beyond the limitation of frame 52 and also in the depressurised state already contact the battery element and be compressed by it in cross-section. The operating overpressure in cooling element 40 then only has the effect of the heat exchanger channels 48 moulding themselves even more and even closer to battery element 10.

Although the embodiment and the shown variants do not expressly provide for the manifold channel 46 and the collector channel 50 to contribute to the heat transfer, this may be provided for in further variants.

In a further variant of cooling element 40 relief structures are provided in only one of the heat exchanger halves 64, 66 (see e.g. FIG. 5) such that they form cavities 76, whilst the other heat exchanger half is flat. In such a cooling element the symmetry plane 70 becomes a general dividing plane in terms of the invention. Such a cooling element may be used for example at the front outside the last battery cells 10 in an array 1.

The invention has been described using lithium-ion battery cells 10, which are typical of an electrochemical energy storage cell in terms of the invention. It is understood that the invention is applicable to any type of electrochemical energy storage cell irrespective in principle of their effect, for which a dissipation of surplus heat could be of advantage.

### LIST OF REFERENCE SYMBOLS

1 battery array
10 battery cell
12 first frame part
14 second frame part
16 holes
18 depression
19 knob
20 bearing
20a hole (blind hole, threaded bore)
30 battery element
32 positive conductor
32 hole (through-hole, fastening hole)
34 negative conductor
34a hole (through-hole, fastening hole)
40 cooling element
40′ manufacturing stage
42 flow connection
44 return connection
46 manifold channel
48 heat exchanger channel
50 collector channel
52 frame
52′ edge bead
54 recess
55 bay
56 bore
58 coolant flow
59 coolant current in cooling path
60 coolant return
62 first layer; first frame half
64 second layer; first heat exchanger half
64′ film sheet
66 third layer; second heat exchanger half
68 fourth layer; second frame half
70 symmetry plane
72a, 72b, 72c juncture
72d connecting layer (juncture)
74, 76 cavity
78, 80 connecting channel
82 stay portion
84 moulding portion
84′ contour in operating state
84a outer surface
86 line (marking the heat exchanger area)
88 edge region
88a corner
90 flap
90a bending line
90b strip
90c incision
92 flap
92a bending line
92b strip
92c incision
94 flow manifold
96 return manifold
100 channel temperature sensor
100 battery control unit
102 control device
104 pump
106 fan motor
108 flow heating device
110 radiator
112 compensating reservoir
114 cooling fan

### LIST OF SYMBOLS

H height of a frame half
h′ height of edge bead
s layer thickness (film thickness)
A contact surface
H height of heating element
Q thermal current; heating output
S_{H} flow heating device control signal
S_{L} fan motor control signal
S_{P pump control signal}
T thickness of heating element
T₁ entry temperature; temperature on the side of one battery cell
T₂ exit temperature; temperature on the side of one cavity
T_{R} return temperature signal
T_{V} flow temperature signal
W width of heating element
Z_{B} battery state signal
λ thermal conductivity

It is specifically pointed out that the above list of reference symbols and the symbol list are an integral part of the description.

1-15. (canceled)

16. A cooling element configured to be disposed between electrochemical energy storage cells, comprising:
a heat exchanger structure configured to have a heat transfer medium can flow therethrough, the heat exchanger structure being formed of at least two film layers, opposing surfaces of the two film layers being placed against one another, the two film layers being connected at junctures within the opposing surfaces, the junctures defining cavities between the opposing surfaces through which the heat transfer medium can be conducted;
a heat transfer medium supply connection; and
a heat transfer medium discharge connection connected to the heat transfer medium supply connection via the cavities,
wherein the cavities, in at least one portion of the heat exchanger structure, form one or more channels which extend in parallel to one another and through which the heat transfer medium flows in a same direction or an opposite direction.

17. The cooling element according to claim 16, wherein walls of the cavities formed by the film layers comprise an elasticity to expand in an operating state in which the heat exchanger structure operates under overpressure from the heat transfer medium relative to a depressurized state, the expansion occurring in a thickness direction of the cooling element.

18. The cooling element according to claim 16, wherein the heat exchanger structure comprises expanding portions that expand in an operating state in which the heat exchanger structure operates under overpressure from the heat transfer medium relative to a depressurized state, the expansion occurring in a thickness direction of the cooling element.

19. The cooling element according to claim 16, wherein the cooling element comprises a frame structure in which the heat exchanger structure is disposed.

20. The cooling element according to claim 19, wherein the frame structure is formed at least of two film layers, respective surfaces of which are arranged opposite one another.

21. The cooling element according to claim 19, wherein the frame structure comprises a stiffening structure.

22. The cooling element according to claim 19, the heat exchanger structure protrudes in thickness direction beyond an expansion defined by the frame structure when operating in an operating state in which the heat exchange structure operates under overpressure from the heat transfer medium, and
in a depressurized state, the heat exchanger structure does not protrude or protrudes less beyond the frame structure than when operating under overpressure or retracts behind an expansion defined by the frame structure.

23. The cooling element according to claim 16, wherein the film layers are comprised of a plastic, and the film layers include a substance influencing thermal conductivity.

24. The cooling element according to claim 16, wherein the heat transfer medium is a liquid heat transfer medium, including at least one of water, an alcohol or glycol.

25. A method for manufacturing a cooling element according to claim 16, comprising:
preparing a first film layer and a second film layer, the first and second film layers being formed of a plastic material;
disposing the first film layer and the second film layer such that surfaces of the first film layer and the second film layer face each other; and
connecting the first and second film layers at junctures formed in the surfaces such that a cavity structure is formed between the junctures, the cavity being open on an edge in at least two places,
wherein a through-connection is formed between the two open places in order to form a heat exchanger structure.

26. The method according to claim 25, wherein the preparing step comprises forming a relief structure in the first and second film layers, the relief structure forming the cavity structure, after the step of connecting the first film layer and the second film layer.

27. The method according to claim 25, further comprising:
introducing a pressure fluid between the first and second film layers, in a heated state, in order to widen the cavity structure, with the aid of a matrix in order to limit widening.

28. The method according to claim 26, further comprising:
forming a substantially circumferential frame structure on an edge on both sides of a dividing plane defined between the first and second film layers.

29. An electrochemical energy storage device comprising a plurality of flat electrochemical energy storage cells whose sides face each other and which are arranged in a stack, a cooling element disposed between each two storage cells, a cooling element formed according to claim 16, wherein heat transfer medium charging connections and heat transfer medium discharging connections of the cooling elements in the electrochemical storage device are respectively connected with a heat transfer medium supply circuit.

30. The cooling element according to claim 20, wherein edge regions of the film layers of the heat exchanger structure are received between film layers of the frame structure.

31. The cooling element according to claim 20, wherein the frame structure is formed of folded edge portions of the film layers of the heat exchanger structure or the frame structure is sprayed or glued onto edge portions of the film layers of the heat exchanger structure as a molding.

32. The cooling element according to claim 21, wherein the stiffening structure includes a plurality of ribs.

33. The cooling element according to claim 23, wherein the film layers comprise PE, PC, PP, PVC, PS or a composite film or a laminate film.

34. The cooling element according to claim 23, wherein the substance influencing conductivity includes quartz powder, glass, metals, aluminum nitride powder or carbon.

35. The cooling element according to claim 24, wherein the liquid heat transfer medium includes a mixture of water and an alcohol at a ration of at least 50:50.
